(19) United States
(12) Patent Application Publication
(10) Pub. No.: US 2015/0127352 A1
(43) Pub. Date: May 7, 2015

(54) Methods, Systems, and Tools for Promoting Literacy

(71) Applicant: UniSkript Corporation, Alamo, CA (US)

(72) Inventor: Robert W. Norsworthy, Alamo, CA (US)

(21) Appl. No.: 14/529,479

(22) Filed: Oct. 31, 2014

Related U.S. Application Data
(60) Provisional application No. 61/900,494, filed on Nov. 6, 2013.

(51) Int. Cl. G10L 25/48

(52) U.S. Cl. CPC G10L 25/48
USPC 704/270

(57) ABSTRACT

Computer-based literacy tools provide users with visual and aural examples of phonemes, associating graphemes with both a respective sound and organ or organs of articulation. The tools can compare a spoken syllable, word, or phrase to the correct phoneme(s) and express any dissonance between the two using iconophonological symbols. Works published in one dialect can be transliterated into another dialect, such as in response to a location or user preference. Iconophonological orthographies can be logically ordered, and can be used to simplify animation.

### TECHNICAL FIELD

The present disclosure is directed to methods, systems, and tools for combating illiteracy. As used herein, “illiteracy” refers to the inability to use orthographic symbols to communicate knowledge and interests within a community at an age-appropriate level. The cost of illiteracy is enormous to the illiterate, their families, and their communities at large. Even where adult illiteracy is uncommon, the time and cost associated with formal literacy instruction are major burdens.

A language's orthography, or writing system, can have a major impact on literacy. Spelling is difficult in English, for example, in part because the alphabet symbols lack consistent pronunciations. Logographic writing systems, notably Japanese and Chinese characters, may have more consistent pronunciations for their symbols, but there are many more symbols, and those symbols are not linked to their pronunciations.

U.S. Patent Publication 2013-0191115 to Suzuki et al. (Suzuki et al.) and entitled “Methods and Systems for Transcribing or Transliterating to an Iconophonological Orthography” (hereafter “Suzuki et al.) describes a writing system that can be adapted for use with any spoken language to greatly ease literacy acquisition. The iconicity of the orthographies represents features of the vocal tract, which limits the number of icons to easily learned sets. This simplification, and the phonological correspondence between the icons and spoken language, makes the orthographies easy to learn. The Suzuki et al. publication is incorporated herein by reference.

The teachings of the Suzuki et al. publication greatly facilitate literacy. Most reading material is not available in iconophonological orthographies, however, and even when they are learning to read and write can be difficult and time consuming. There is therefore a need for methods, systems, and tools for teaching and promoting literacy.

### BRIEF DESCRIPTION OF THE FIGURES

FIG. 1A depicts five instances of a cross section 100 of the human head illustrating aspects of a vocal tract, including the lips, tongue, and larynx.

FIG. 1B illustrates the iconic representations of the primary organs of constriction introduced in FIG. 1A absent cross sections 100 for ease of illustration.

FIG. 2 depicts six diacritical marks, or diacritics, that can be used alone or in combination with other glyphs to complement the phonological specifications of the segment of GA English.

FIG. 3 is a flowchart 300 illustrating the application of the procedure of FIG. 1 to the consonant phoneme “V,” as in Victor, to develop an iconophonological grapheme in accordance with one embodiment.

FIG. 4 is a flowchart 400 detailing how a vowel phoneme is derived in accordance with one embodiment.

FIG. 5A shows nine instances of a cross section 100 of FIGS. 1A and 1B representing the shape of a vocal tract for vowel expression.

FIG. 5B replicates head cross section 100 four times to illustrate exemplary iconic representations of phonological gestures used to express a pair of diphthongs.

FIG. 6 shows an iconophonological orthography for general-American (GA) English in accordance with one embodiment.

FIG. 7 is a flowchart 700 illustrating a method of transliterating words expressed in a first orthography—GA English—into the iconophonological orthography depicted in FIG. 6.

FIG. 8 illustrates how a reader of the iconophonological orthography in accordance with the embodiments described in connection with FIG. 6 can sound out the word “system” derived in the example of FIG. 7.

FIG. 9 is a flowchart depicting a method 900 for highlighting auditory dissonance to aid a speaker in language acquisition.

FIG. 10 is a flowchart 1000 illustrating how a computing device can automatically publish content in a local dialect.

FIG. 11A depicts a flowchart 1100 illustrating an animation technique that employs an iconophonological orthography.

FIG. 11B depicts a number of exemplary visemes that represent a subset of the phonemes illustrated in FIG. 6.

FIG. 12 depicts the orthography of FIG. 6 with constituent graphemes ordered using a collation convention in accordance one embodiment.

FIG. 13 is a block diagram of an iPhone 1300, an Internet-connected multimedia smart phone available from Apple Inc. of Cupertino, California.

The figures are illustrations by way of example, and not by way of limitation. Like reference numerals in the figures refer to similar elements.

### DETAILED DESCRIPTION

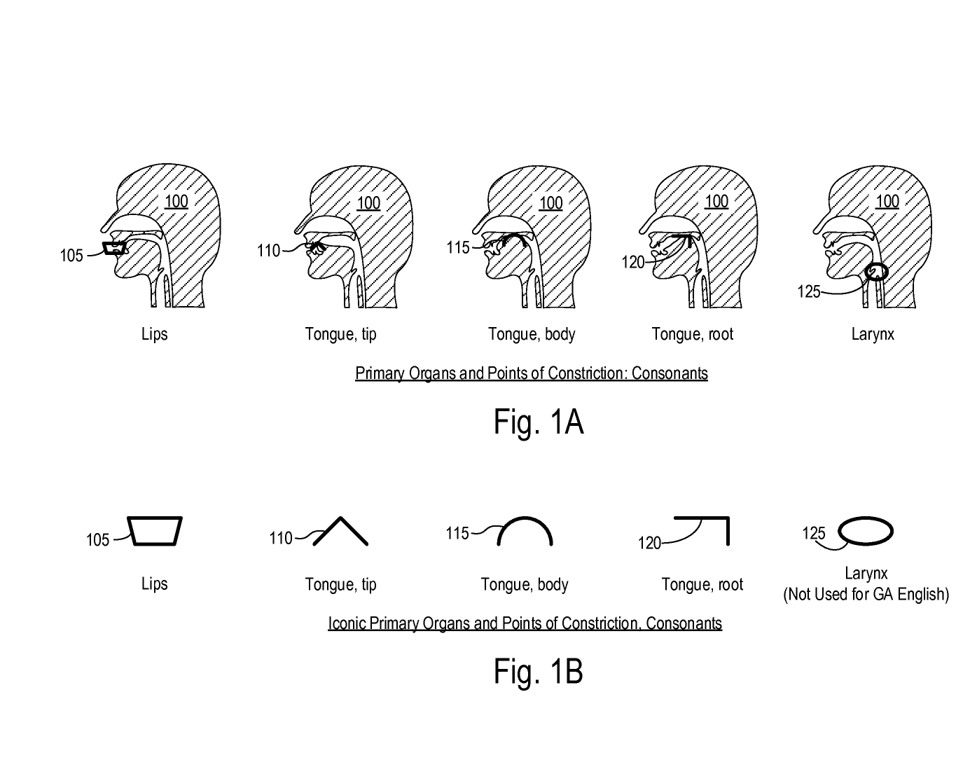

FIG. 1A depicts five instances of a cross section 100 of the human head illustrating aspects of a vocal tract, including the lips, tongue, and larynx. Iconic representations of these physical structures identify five primary organs of constriction, each one of them implying a corresponding place of articulation where a constriction is produced. From left to right, a polygon 105 represents the lips, an inverted “V” 110 the tip of the tongue, an inverted “U” 115 the body of the tongue, a step 120 the root of the tongue, and an ellipse 125 the larynx.

FIG. 1B illustrates the iconic representations of the primary organs of constriction introduced in FIG. 1A absent cross sections 100 for ease of illustration. The following discussion details the development of an orthography of General American (GA) English. GA English may include but does not require the larynx representation for graphemes, so the larynx icon may be omitted.

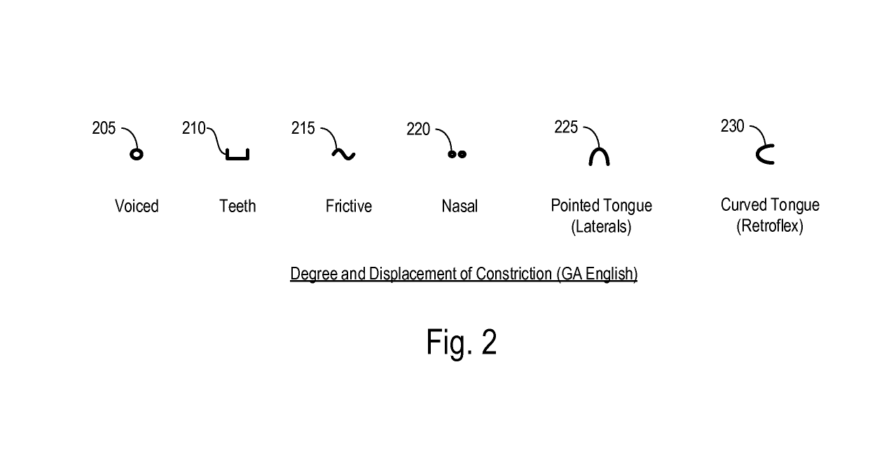

FIG. 2 depicts six diacritical marks, or diacritics, that can be used alone or in combination with other glyphs to complement the phonological specifications of the segment of GA English. These include a “voiced” diacritic 205, a “teeth” diacritic 210, a “fricative” diacritic 215, a “nasal” diacritic 220, a “lateral” diacritic 225, and a “retroflex” diacritic 230. Voiced diacritic 205 indicates that the corresponding consonant is voiced; diacritic 210 that the corresponding consonant is enunciated using the teeth; diacritic 215 that the corresponding consonant is enunciated using enough friction to create a sibilant, hissing, or buzzing quality; nasal diacritic 220 that the corresponding consonant resonates in the nasal cavity (nose); tongue diacritic 225 that the corresponding consonant is enunciated using the laterals of the tongue lowered (as in the pronunciation of the English “L”); and tongue diacritic 230 that the corresponding consonant is articulated with a retroflex tongue (curved towards the back of the oral cavity).

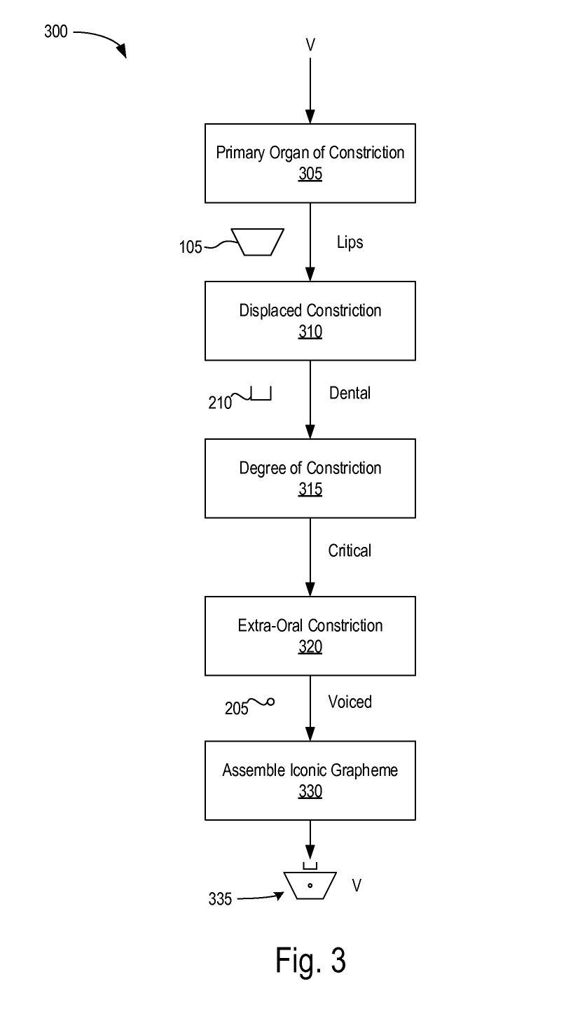

FIG. 3 is a flowchart 300 illustrating the application of the procedure of FIG. 1 to the consonant phoneme “V,” as in Victor, to develop an iconophonological grapheme in accordance with one embodiment. First, at 305, the lips are identified as the primary organ of constriction, and icon 105 of FIG. 1 is selected accordingly. (In general, the first digit of each numerically identified element refers to the Figure in which the element was introduced.) This identification can be done by anyone familiar with the pronunciation of the phoneme in question. The reader is invited to pronounce the “V” sound, and will doubtless observe that the lips are the primary organ of constriction, and not the tongue or larynx.

Next, place of constriction is characterized in 310. In enunciating the “V” sound, one will readily observe that the lower tip retracts to touch the upper teeth. The constriction is therefore displaced, and is consequently identified in 310. Teeth diacritic 210 is therefore selected to represent this point of articulation. The enunciation of the “V” sound also indicates that the degree of constriction is critical, and this is noted in 315, but this critical constriction is implied in any labio-dental articulation, so it need not be marked with a specific diacritic. An extra-oral constriction is required, however, as the “V” sound must be vocalized, or “voiced,” to distinguish it from the “F” sound. This attribute is noted using the diacritic 205 assigned to voicing. Finally, at 325, an iconic grapheme 330 is assembled using the identified collection of glyphs. Grapheme 335 includes all the information required to represent the phoneme for “V” in GA English, as this phoneme is the only voiced consonant formed using the lips and teeth.

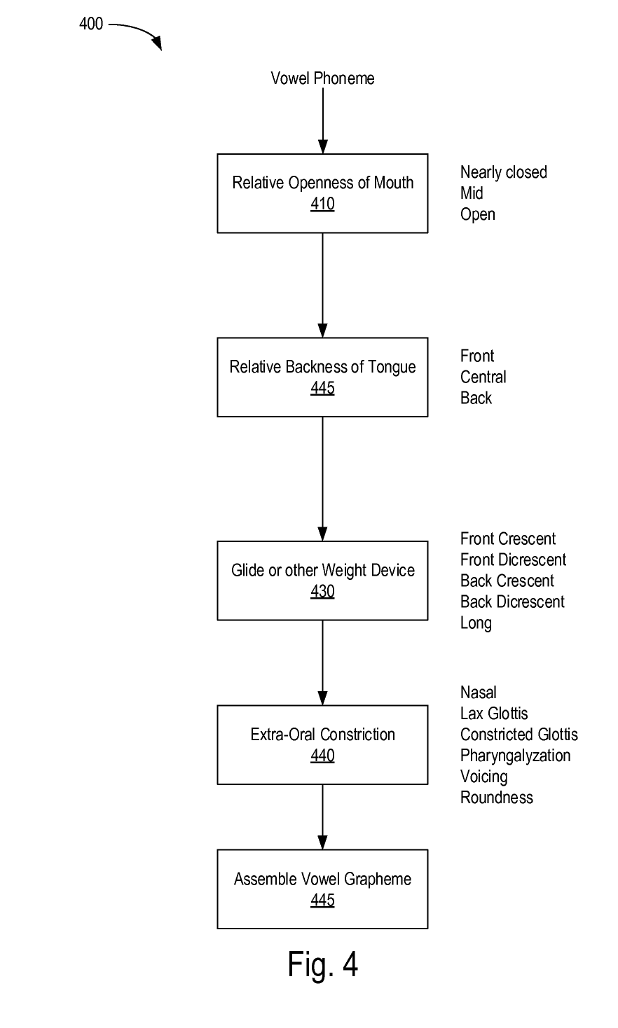

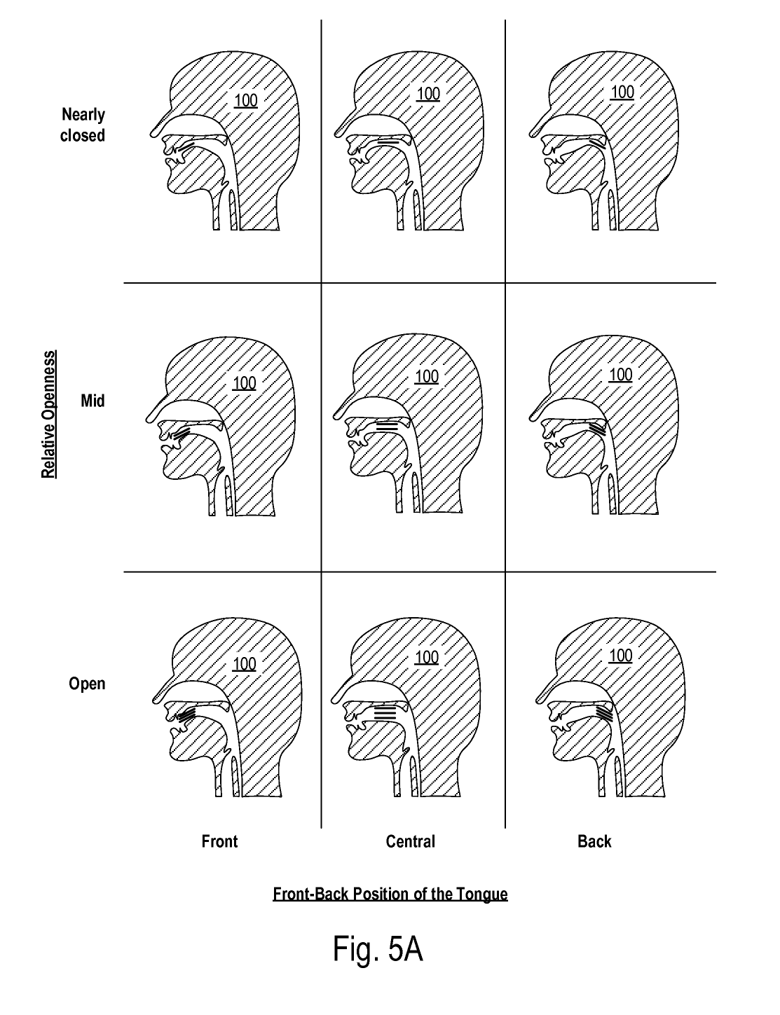

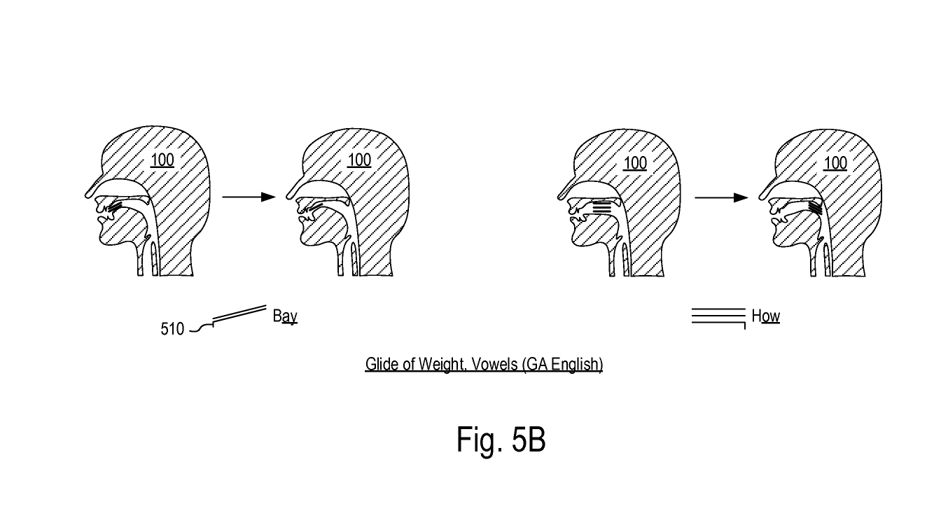

FIG. 4 is a flowchart 400 detailing how a vowel phoneme is derived in accordance with one embodiment. The first step (710) is to determine the relative openness of the mouth when forming the phoneme of interest. As depicted in FIG. 5A, the relative openness can be characterized as nearly closed (low), mid, or open. In this example, relative openness is represented using from one to three lines, as illustrated in the cross sections 100 of FIG. 5A.

The next step in the flowchart of FIG. 4, though the steps need not be in this order, is to determine the relative horizontal position, or “backness/frontness,” of the speaker's tongue in enunciating the vowel of interest (step 430). Returning to FIG. 5A, horizontal tongue position can be characterized as front, central, or back. This embodiment indicates horizontal tongue position using the slope of the line or lines used to designate openness. Using the lips as a reference, upward sloping lines represent a front tongue position, horizontal lines a central position, and downward sloping lines a back tongue position. Other graphical representations of openness and backness/frontness can be used in other embodiments.

Returning to FIG. 4, the third question for vowels indicates whether there is any mechanism of weight increasing in the vowel, such as lengthening or gliding. In this example, glides or weight devices are categorized as decrescent glides, front crescent glides, back decrescent glides, back crescent glides, and long vowels. Diacritical or other identifiers or graphic modifications are assigned as needed. In some embodiments detailed below, the line or lines developed in steps 410 and 430 are modified as needed to distinguish those with some distinguishing property noted in step 445.

FIG. 5B replicates head cross section 100 four times to illustrate exemplary iconic representations of phonological gestures used to express a pair of diphthongs, which are gliding monosyllabic speech sounds that start at or near the articulatory position for one vowel and move to or toward the position of another. In the example on the left, the vocal-tract shape morphs from a mid-constriction at the front of the vocal tract to a near-closed constriction during the enunciation of the same syllable, as in the vowel sound in “bay.” This example represents this diphthong using two sloped, parallel lines of the starting position and a diacritic 510 at the front of the grapheme to illustrate that the final sound is also formed using the front of the mouth. The right-hand example represents the diphthong for the vowel sound in “how” using three horizontal lines of the starting position and a diacritic at the end of the grapheme to illustrate that the final sound is formed using the back of the mouth. These and other diphthongs are discussed below.

Some vowel phonemes require some extra-oral constriction, and these are distinguished in step 470. In this example, these extra-oral constriction possibilities are identified as in the consonant example of FIG. 2. Finally, at step 475, an iconic grapheme is assembled based on the findings from steps 410, 430, 445, and 470.

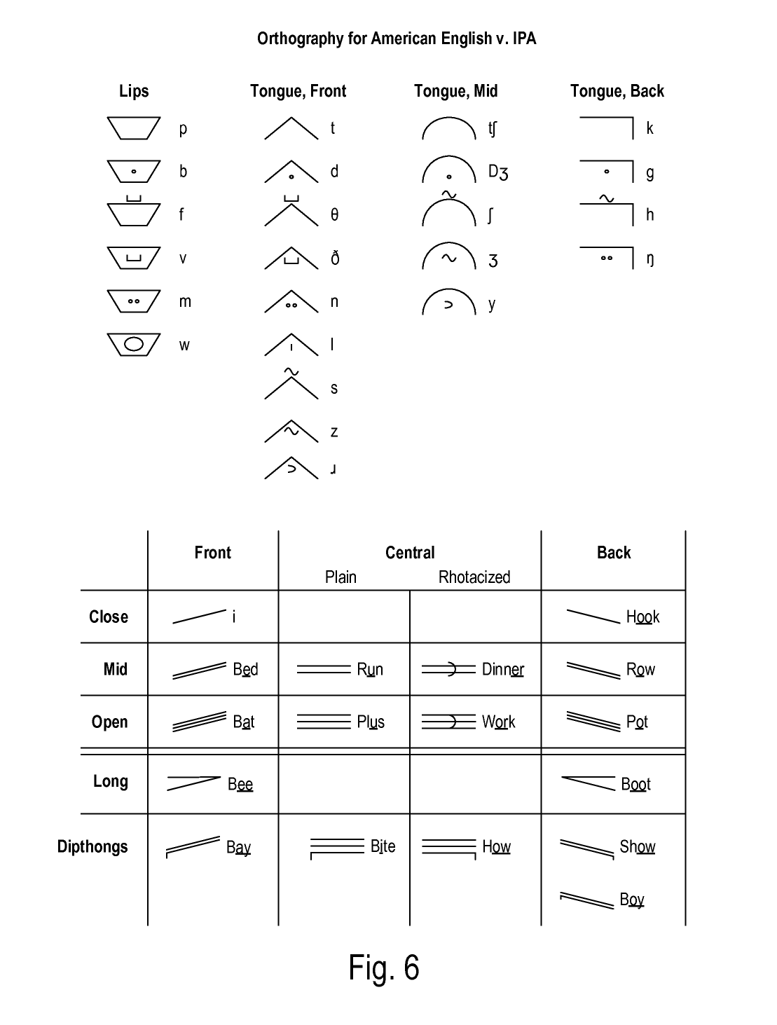

FIG. 6 shows an iconophonological orthography for general-American (GA) English in accordance with one embodiment. Each grapheme is associated with a phoneme and a visual representation of a corresponding phonological feature of a vocal tract using the techniques detailed previously. A simple database can maintain these associations.

The consonant graphemes in this example are modified slightly as compared with the embodiment of FIG. 1; namely, voiced consonants are indicated by placing the diacritic within the primary symbol rather than with a separate diacritic. The difference between and “F” and a “V” phoneme, for example, is that the dental diacritic is placed within the lip icon for the latter phoneme. The consonants are mapped to the IPA symbols for the corresponding sounds. The vowels can similarly be mapped. The mapping may vary, however, due to perceived differences in pronunciation and due to phonological processes of assimilation and dissimilation. In English, different spellings can be used for the same phoneme (e.g., rude and food have the same vowel sounds), and the same letter (or combination of letters) can represent different phonemes (e.g., the “th” consonant sounds of “thin” and “this” are different). To avoid this confusion based on orthography, Phonologists represent phonemes by writing them between two slashes: “/ /”. On the other hand, references to variations of phonemes or attempts at representing actual speech sounds are usually enclosed by square brackets: “[ ]”. The symbols of FIG. 6 correspond to phonemes. In other embodiments the orthography can be expanded, condensed, or otherwise altered. Such modifications are to be expected, as the phonemes used to express languages and dialects are subject to interpretation and evolve with time.

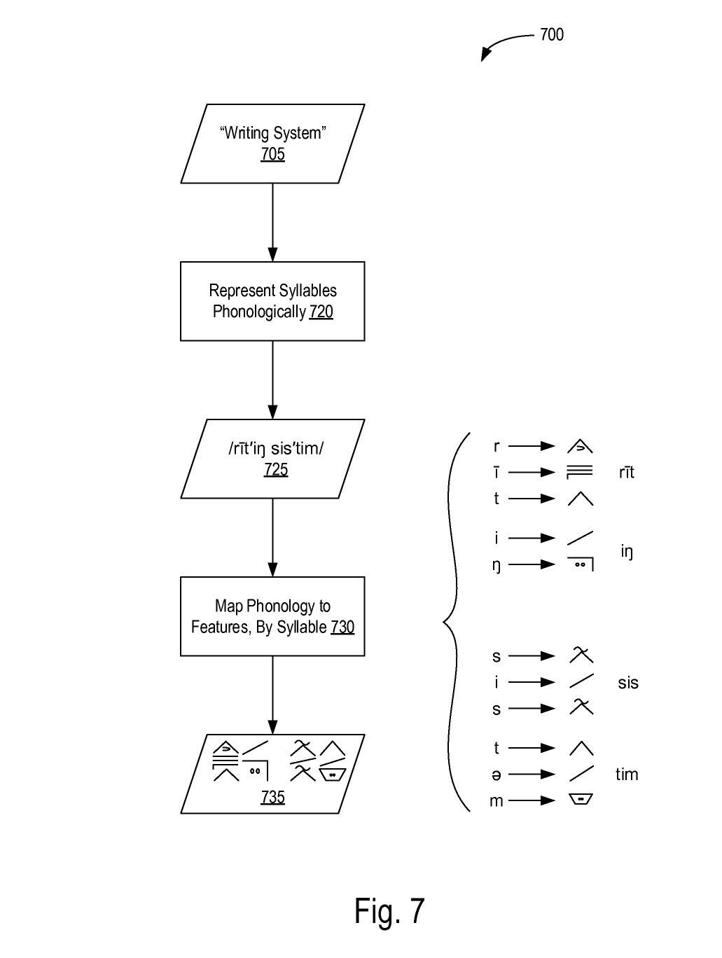

FIG. 7 is a flowchart 700 illustrating a method of transliterating words expressed in a first orthography—GA English—into the iconophonological orthography depicted in FIG. 6. This example transliterates each of four syllables that make up the words “writing system” into homophonic representations based on the iconophonological graphemes discussed above. The method can, of course, be extended to any other words or phrases for which constituent phonological features and gestures are represented in FIG. 6.

Beginning with step 705, the words “writing system” are provided as input, such as during the transliteration of a document recorded using the English Alphabet. The alphabetic words are broken into syllables and represented phonologically (step 720), as shown in phonology 725. Step 720 can be accomplished using available phonological dictionaries of the English language, which are readily available to those of skill in the art. Finally, in step 730, the phonology of 725 is mapped to the orthography of FIG. 6. This mapping is illustrated to the right of the flowchart, and leads to the representation of 735.

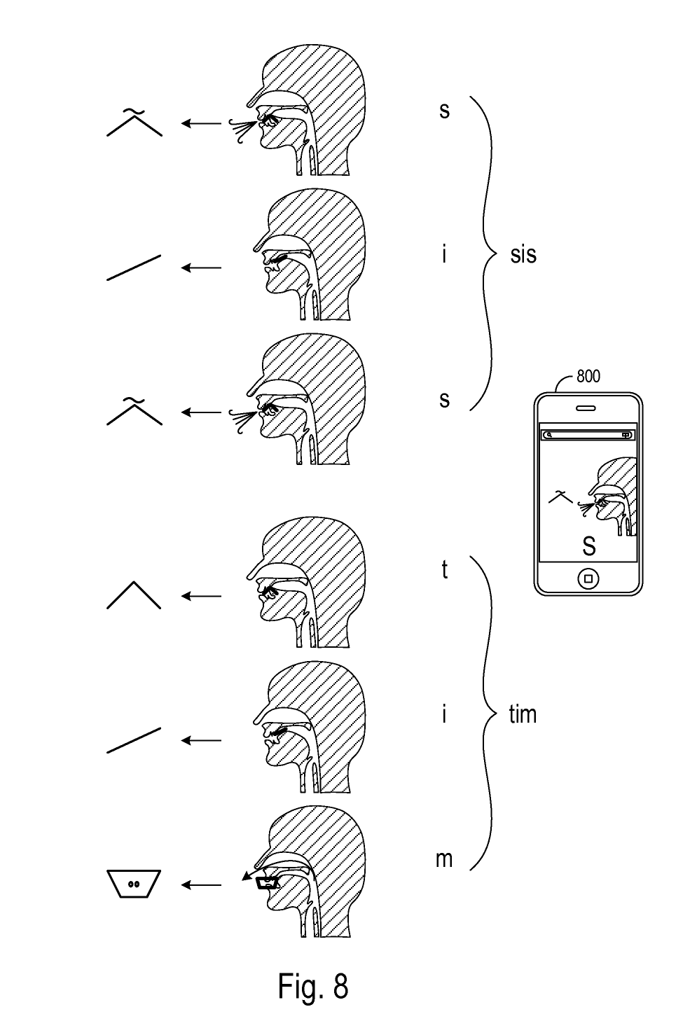

FIG. 8 illustrates how a reader of the iconophonological orthography in accordance with the embodiments described in connection with FIG. 6 can sound out the word “system” derived in the example of FIG. 7. The first syllable, pronounced “sis,” begins with the grapheme representing the tip of the tongue as the primary organ of construction and including a diacritic that stands for the alveolar fricative. The corresponding vocal-tract cross section reminds the reader of the placement of the tongue and includes graphic representation of a burst of air to represent the fricative. Placing the tongue as indicated, and adding the fricative, creates the “s” sound. This first phoneme of a syllable is termed the “onset.”

The vowel portion of “sis” is represented using a single line sloped upward. As described previously, this represents a relatively closed vowel sound formed at the front of the mouth. Forming the vocal tract according to this prescription produces the sound “i”. The final phoneme of the first syllable, referred to as the coda, is once again represented using the grapheme that iconically indicates the tongue tip and fricative. The reader combines these three sounds to produce the syllable “sis.”

The second syllable is sounded out in the same fashion as the first. The onset is similar to the last syllable, but lacks the fricative. Absent a secondary point of articulation, the tip of the tongue forms the “t” consonant sound. The nucleus of the syllable is the same as for the last syllable. The coda is, as shown in the vocal-tract cross section, formed using the lips and includes the nasal diacritic to indicate a secondary point of articulation. The sound formed using the lips and nose is the consonant sound for “m.” The reader is thus able to recreate the encoded word.

These graphemes used in the foregoing examples are iconographic, which makes them relatively easy to remember. The iconicity is based on features of the vocal tract rather than things or ideas, which greatly reduces the requisite number of symbols. Graphemes of the type described in connection with these embodiments thus provide extraordinary economy for representing, teaching, and learning orthographies. The orthography of FIG. 6, for example, employs just ten iconic symbols, logically grouped by organ of articulation, to represent all the consonant sounds. All the vowel sounds are represented by simple organizations of lines. Both the consonant and vowel graphemes are constructed following logical rules that make the orthography easy to learn. Indeed, a reader familiar with the patterns and symbols used to express the sounds can easily extend the symbol set to unknown or forgotten phonemes, or can sound out unknown or forgotten graphemes.

### Computer-Based Literacy Tools

FIG. 8 can also be used to illustrate how a computing device, such as a personal computer or digital assistant 800 (e.g., a smartphone supporting the ANDROID or IOS operating system), may be programmed in accordance with one embodiment to create a tool for promoting literacy.

Conventional pronunciation applications, such as the PROPOWER app available for the iPhone, provide users with visual examples of phonemes. The user's device accepts user input expressing one of the phonemes. Using the PROPOWER app, for example, the user can scroll through graphemes that represent phonemes and select one for illustration. The illustration of a requested phoneme can be either a frontal view of a human face to show lip movement or a cross-section of a vocal tract to review the placement and usage of the organs of articulation. The app also causes the device to emit the associated phoneme via a speaker.

Such applications can be extended in accordance with one embodiment such that the visual examples “spit” out, by animation, an iconophonological grapheme or set of graphemes for text of interest. In the example of FIG. 8, an animated vocal tract could sequentially emit the visual graphemes in the left-hand column timed with synchronized audio of individual phonemes or entire spoken words or phrases. Associating the grapheme with both the sound and organ or organs of articulation promotes literacy. User input expressing a phoneme or phonemes of interest can be vocal in other embodiments.

### Highlighting Auditory Dissonance to Correct Pronunciation

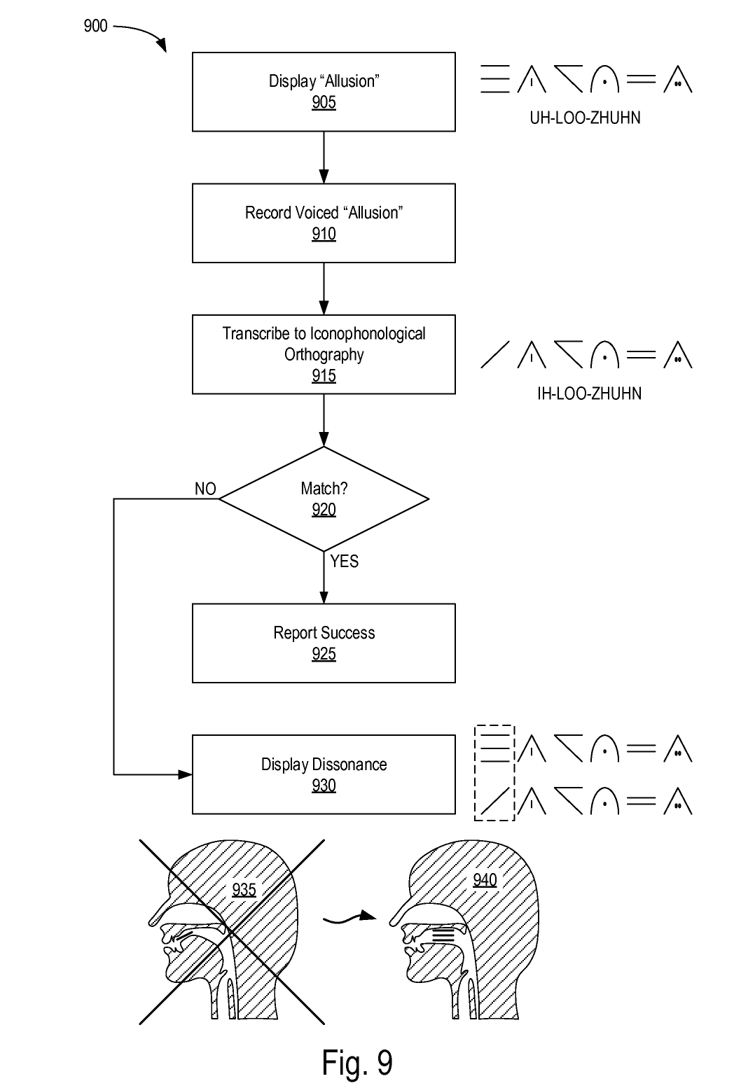

FIG. 9 is a flowchart depicting a method 900 for highlighting auditory dissonance to aid a speaker in language acquisition. The method can be performed using a computing device, a combination of software and hardware (e.g., a software application running on a general-purpose computer or handheld device).

In this embodiment, the student is prompted to say a word or sentence. In other words, the computing device prompts the user to speak a requested phoneme or phonemes. In this example, the word “allusion” is displayed with a prompt to speak the word (905). The correct pronunciation of “allusion” is noted to the right of 905 using both the orthography of FIG. 6 and using Roman characters.

The student user then articulates the requested phoneme or phonemes, and the computing device records the resultant expressed phoneme or phonemes. In this example, the user reads the word “allusion” aloud and the speech is recorded (910). The recorded speech is than transcribed into an iconophonological orthography, the orthography of FIG. 6 in this instance (915). As shown to the right of 915, in this example the student mistakenly articulated the word “illusion” rather than the requested “allusion.” This incorrect pronunciation is illustrated using both the orthography of FIG. 6 and using Roman characters.

The computing device compares the requested phoneme(s) with the transcribed expressed phoneme(s). Per decision 920, if the requested and expressed versions match, then the computing device displays or sounds some feedback indicative of a successful pronunciation. If the transcribed iconophonological representation does not match the reference sound however, as in the instant example, the device provides the student with visual and/or auditory feedback specifying the dissonance. Here, the first syllable of the mispronounced word is incorrect. The correction could be indicated by visually highlighting the mistake, providing the correct sound, etc.

A pair of cross sections 935 and 940 show how a cross-section of the vocal tract, or a combination of such cross-section and related symbols, can help the student achieve the correct pronunciation. Such cross-sections are relatively complex and area-intensive, however, so the student might be encouraged to glean the same information from the iconophonological properties of the orthography.

### Transliteration Between Dialects

Modern communication devices commonly include a GPS receiver, or some other mechanism for securing location information. Publishers can use this location awareness to publish text in a location-appropriate dialect; readers can likewise use this location awareness to receive content in the local dialect. In other embodiments the publisher, reader, or both can select a location or a dialect.

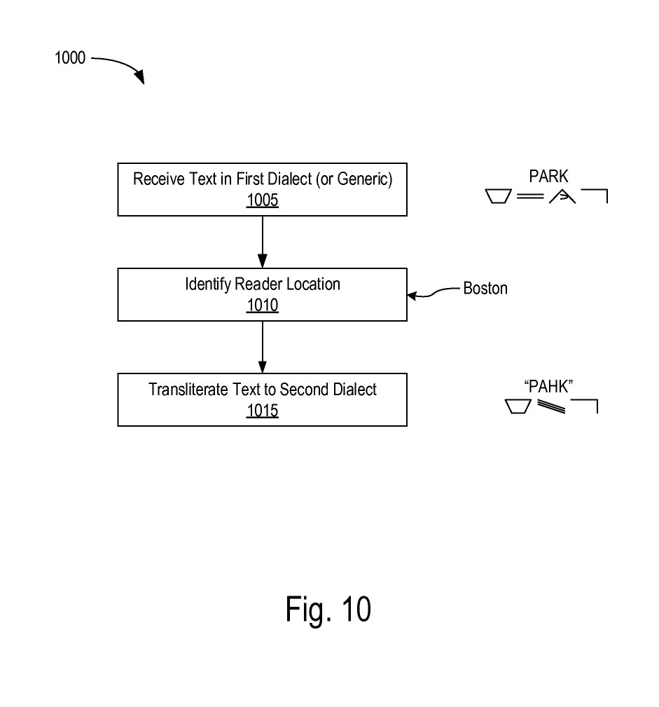

FIG. 10 is a flowchart 1000 illustrating how a computing device can automatically publish content in a local dialect. The computing device stores a database that includes pronunciation keys for a number of dialects, and associates each dialect with a geographic location. In the following example, a computing device stores a pronunciation key for a dialect associated with the U.S. city of Boston, Mass. The database can be on a mobile device, or can be maintained remotely (e.g., “in the cloud) on a server remote from the reader.

A publisher publishes material in a first dialect (e.g., General American), or in some generic form (1005). In this example, the publisher provides the English word “Park.” Next, either the publisher or a device associated with the reader identifies the reader's location (1010), the Boston area in this example. This step may be done by prompting the reader, referring to a GPS on the reader's device, maintaining a database of reader addresses, etc., and may be done either at a publisher's server or the reader's device.

However the location is obtained, the text is transliterated from the first dialect to the selected dialect with reference to the pronunciation key for the selected dialect (1015). The Boston area has a unique and recognizable dialect in which “park” is famously pronounced “pahk.” The Boston version of “park” is depicted in the iconophonological orthography of FIG. 6 to the right of 1015. The transliteration process may be done remote from the reader (e.g., at a server controlled by the publisher), at the reader's device, or the process can be shared between these and other computational resources. In other embodiments the selection of the second dialect may be based on information other than locations, such as by reference to a reader's selected or historical preference.

### Animation Using Iconophonological Orthographies

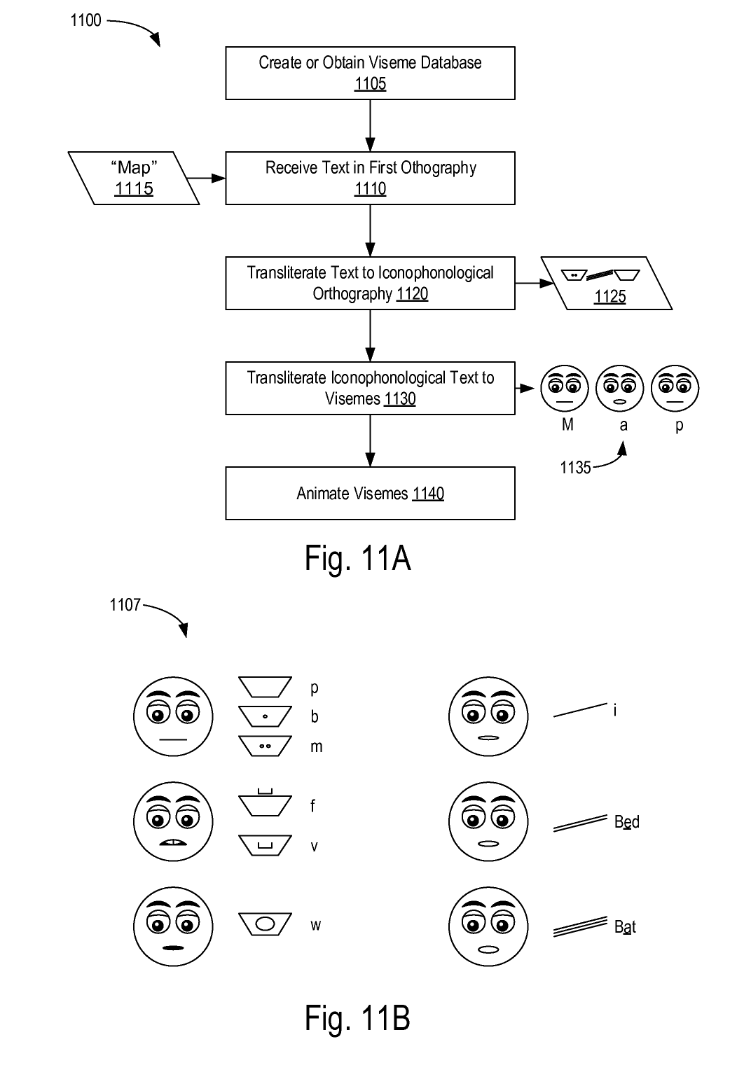

Iconophonological orthographies of the type illustrated herein simplify the process of facial animation. With reference to the method depicted as flowchart 1100 in FIG. 11A, one first creates or obtains a database of “visemes” (1105). Each viseme is a visual representation of the face of an animated figure appears when expressing a phoneme.

FIG. 11B depicts a number of exemplary visemes that represent a subset of the phonemes illustrated in FIG. 6. The three visemes of the left column represent the phonemes for which lips are the primary organ of articulation. The three visemes of the right column represent the phonemes for the three “front” vowel phonemes. Visemes can likewise be created for the other sounds (e.g., the remaining phonemes of FIG. 6), but are omitted here for ease of illustration.

Returning to FIG. 11A, and having access to a viseme database, the depicted embodiment receives text in a first orthography (1110). In this example, the text is the word “map” (1115) and the orthography is the English Alphabet. Next, the text is transliterated into an iconophonological orthography (1120), in this case to the orthography of FIG. 6 (1125). Employing the viseme database, the transliterated text 1125 is again transliterated (1130), this time to a string of visemes 1135 representative of the initial text 1115. Finally, the visemes are presented in time series to animate pronunciation of the word. Though no shown, the viseme database can be extended to include transitional visemes to visually smooth transitions from one viseme to the next.

### Collation Using Iconophonological Orthographies

Collation is the assembly of written information into a standard order. Common examples of collated information include words in a dictionary or index, names in a phone directory, or alphanumeric database entries. In the English language, the process of collating letters and words is termed “alphabetizing,” a process with which the reader is doubtless aware. Briefly, strings of characters are ordered based on the position of each character in the string and the standard ordering convention colloquially termed the “ABCs”. Some orthographies, such as those used to represent Japanese and Chinese languages, collate using ordering conventions that are based on phonemes. Either approach requires the collator to memorize the standard convention.

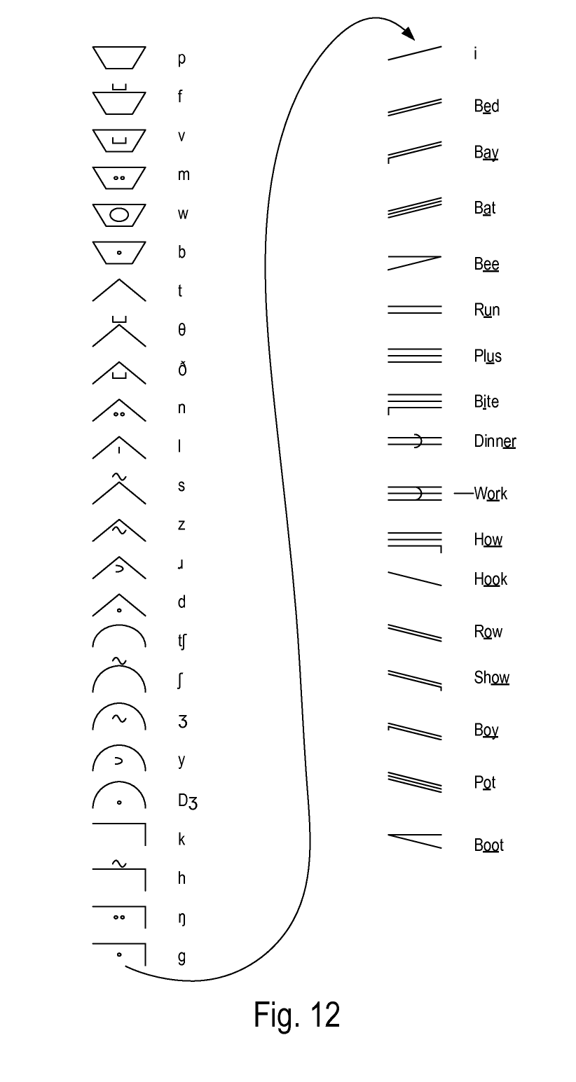

FIG. 12 depicts the orthography of FIG. 6 with constituent graphemes ordered using a collation convention in accordance one embodiment. This convention is easy to memorize and employ due to attributes of the iconophonological orthographies used in the ordering. Rather than a relatively arbitrary order of letters or sounds, graphemes are grouped based on organs of articulation and ordered based on the relative positions of those organs in the vocal tract.

With reference to FIG. 6, a collation convention in accordance with one embodiment places consonant graphemes first, grouped by primary organ of articulation as shown, and ordered based on the vocal tract from front to back (lips, front tongue, mid tongue, back tongue). Each group is ordered based on the secondary organ of articulation, again from front to back of the vocal tract. With reference to FIG. 2, and approximating a front-to-back ordering, one embodiment orders secondary organs of articulation thusly: teeth, frictive, nasal, pointed tongue, curved tongue, and voiced. In this collation scheme, graphemes with more or implied secondary organs are placed lower in the ordering. Lips alone, as in the IPA sound “p,” for example, comes before the “f” consonant due to the need for a “teeth” symbol for the secondary organ, and the “f” consonant precedes the “v” consonant due to the implied voicing annotated by placing the teeth within the lips symbol.

Vowels in accordance with this embodiment of a collation convention are likewise ordered based on the primary organ of articulation, front to back as illustrated in the vowel columns of FIG. 6. Those four groups are sub-ordered based primarily upon the relative openness of the mouth, with narrower openings being foremost in the ordering.

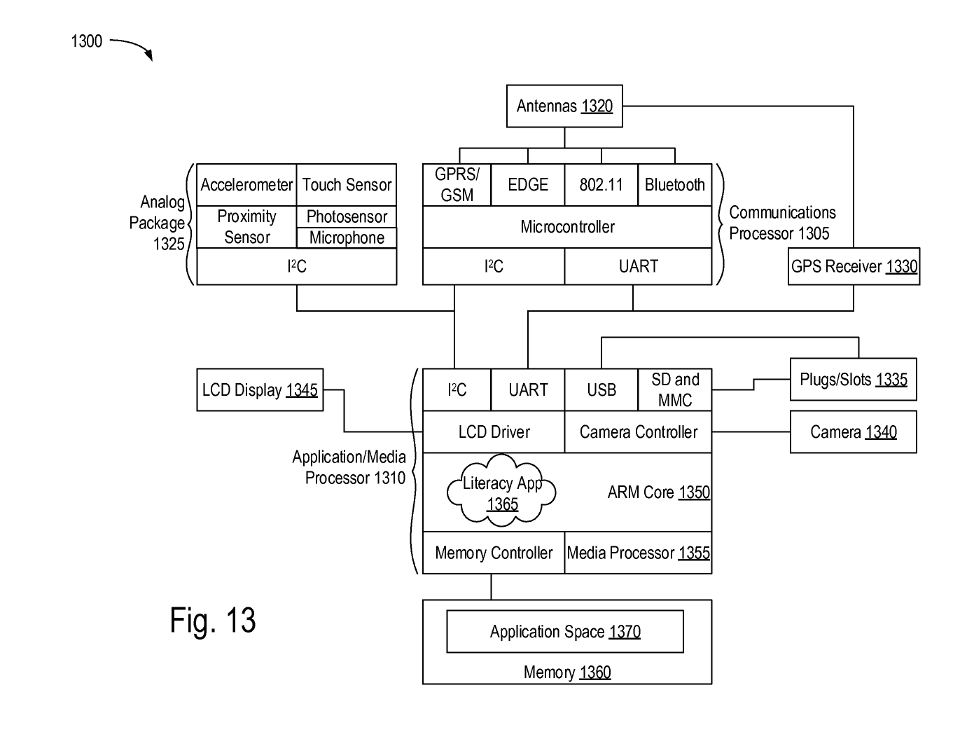

FIG. 13 is a block diagram of an iPhone 1300, an Internet-connected multimedia smart phone available from Apple Inc. of Cupertino, Calif. Phone 1300 can be provided with applications, or “apps,” that produce visual feedback for pronunciation and transliterate between dialects in the manner described above. The visual feedback can include animation, but support for animation may be separate from tools used for literacy acquisition.

Phone 1300 is one of many readily available platforms easily adapted for use as a literacy-acquisition tool. Phone 1300 and its constituent components are well understood by those of skill in the art. A brief description of the phone systems and subsystems is provided for context.

Phone 1300 includes two processors, a communications processor 1305 and an application/media processor 1310, that are interconnected by a pair of serial interfaces I2C (for Inter-Integrated Circuit) and UART (for Universal Asynchronous Receiver/Transmitter). Communications processor 1305, sometimes called a baseband processor, supports widely used wireless communication protocols, GPRS/GSM, EDGE, 802.11, and Bluetooth, and is coupled to a respective set of antennas 1320 for this purpose. The GPRS/GSM block, part of the cellular front end, can be adapted to support different cellular communication standards in other embodiments. Phones in accordance with still other embodiments communicate via networks other than cellular networks, in which case the function of the cellular front end is provided by a different form of wireless network interface.

Processor 1310 is at the heart of the phone, and includes support for a number of input/output devices in addition to what is provided by the communications processor. An analog package 1325 includes an accelerometer, a touch sensor, a proximity sensor, and a photosensor. The accelerometer allows the application processor to sense changes in phone orientation, the touch sensor supports the user interface, the proximity sensor senses e.g. that the phone is near or far from the user's cheek or the difference between a cheek and a fingertip, the photosensor provides a measure of ambient light for e.g. adjusting display backlighting, and a microphone accepts spoken and other sound as input. Other useful input comes from a GPS receiver 1330, plugs/slots 1335 that support memory cards and a USB port, and a camera 1340. Other sensors can be included but are not shown. User output is provided by an LCD display 1345 and, though not shown, a speaker, headphone jack, and a motor supporting a vibrating alert.

Processor 1310 includes two sub-processors, a general purpose ARM (Advanced RISC Machine) core 1350 and a media processor 1355 dedicated to the efficient processing of audio and video data. A memory device or module (multiple memory die) 1360 stores instructions and data for processor 1310. Memory 1360 is implemented using e.g. synchronous dynamic random access memory (SDRAM). Phone 1300 is programmed, in accordance with one embodiment, to execute a literacy application 1365 that supports some or all of the functions detailed above in connection with the foregoing embodiments. The processes illustrated above can also be implemented on other types of computers and systems, which may be general-purpose and dedicated to literacy.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention, which is instead defined by the appended claims.

1. A method for literacy instruction on a computing device, the method comprising:
associating each of a plurality of graphemes, including vowel graphemes and consonant graphemes, with a phoneme and a visual representation of a corresponding phonological feature of a vocal tract;
receiving user input expressing one of the phonemes; and
displaying the grapheme and the visual representation of the phonological feature associated with the expressed phoneme.

2. The method of claim 1, the computing device including a microphone, wherein receiving the user input includes sensing the expressed phoneme with the microphone.

3. The method of claim 2, further comprising prompting the user to speak a requested phoneme from among the phonemes, wherein the user input is responsive to the prompting.

4. The method of claim 3, further comprising highlighting a dissonance between the requested phoneme and the expressed phoneme.

5. The method of claim 4, wherein highlighting the dissonance comprises depicting a difference between the visual representation associated with the requested phoneme and the visual representation associated with the expressed phoneme.

6. The method of claim 4, wherein highlighting the dissonance comprises displaying at least one of the grapheme associated with the requested phoneme and the grapheme associated with the expressed phoneme.

7. A computing device comprising:
a memory to associate each of a plurality of graphemes, including vowel graphemes and consonant graphemes, with a phoneme and a visual representation of a corresponding phonological feature of a vocal tract;
a sensor to sense user input expressing one of the phonemes;
a processor to select, responsive to the user input, the grapheme and the visual representation of the phonological feature associated with the expressed phoneme; and
a display to display the grapheme and the visual representation.

8. The device of claim 7, wherein the sensor comprises a microphone, and wherein sensing the user input includes sensing the expressed phoneme with the microphone.

9. The device of claim 8, the processor to identify a dissonance between the requested phoneme and the expressed phoneme and to convey the dissonance to the display.

10. The device of claim 9, the display to depict the dissonance as a difference between the visual representation associated with the requested phoneme and the visual representation associated with the expressed phoneme.

11. The device of claim 10, wherein depicting the dissonance comprises displaying at least one of the grapheme associated with the requested phoneme and the grapheme associated with the expressed phoneme.

12-20. (canceled)

21. A method of collating strings of characters expressed in an iconophonological orthography, the method comprising:
identifying a first grapheme in each of the strings, each grapheme associated with a primary organ of articulation positioned within a vocal tract;
sorting the strings into groups, each group based on the primary organs of articulation for the first graphemes; and
ordering the groups sequentially in relation to an order of a position of the corresponding primary organ of articulation within the vocal tract.

22. The method of claim 21, further comprising sorting the strings in each group of strings based upon secondary organs of articulation for the first graphemes.

23. The method of claim 22, further comprising ordering the strings in each group of strings sequentially in relation to an order of the position of the corresponding secondary organ of articulation within the vocal tract.
